(19) United States
(12) Patent Application Publication
(10) Pub. No.: US 2024/0422497 A1
(43) Pub. Date: Dec. 19, 2024

(54) PORTABLE ELECTRONIC DEVICE AND METHOD FOR ADJUSTING SOUND OUTPUT CHANNELS ACCORDING TO DIFFERENT ORIENTATIONS

(71) Applicant: ASTI GLOBAL INC., TAIWAN, Taichung City (TW)

(72) Inventor: CHIEN-SHOU LIAO, Taichung City (TW)

(21) Appl. No.: 18/675,110

(22) Filed: May 27, 2024

Related U.S. Application Data
(60) Provisional application No. 63/521,748, filed on Jun. 19, 2023.

(51) Int. Cl. H04S 7/00; H04R 5/02

(52) U.S. Cl. CPC H04S 7/302; H04R 5/02; H04R 2205/022; H04R 2499/11

(57) ABSTRACT

A portable electronic device and a method for adjusting sound output channels according to different orientations are provided. The portable electronic device includes a first speaker module, a second speaker module, a third speaker module and a fourth speaker module. The first speaker module and the second speaker module correspond to each other. The third speaker module and the fourth speaker module correspond to each other. When the orientation of the portable electronic device is horizontal, a first audio signal provided by the first speaker module and a second audio signal provided by the second speaker module cooperate with each other to present a first stereo sound. When the orientation of the portable electronic device is upright, a third audio signal provided by the third speaker module and a fourth audio signal provided by the fourth speaker module cooperate with each other to present a second stereo sound.

### CROSS-REFERENCE TO RELATED PATENT APPLICATION

This application claims the benefit of priority to the U.S. Provisional Patent Application Ser. No. 63/521,748, filed on Jun. 19, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a portable electronic device, and more particularly to a portable electronic device for adjusting sound output channels according to different orientations, and a method for adjusting sound output channels according to different orientations.

### BACKGROUND OF THE DISCLOSURE

In the related art, a smartphone can only provide mono output from one side thereof, thus failing to provide the user with a better listening experience.

### SUMMARY OF THE DISCLOSURE

In response to the above-referenced technical inadequacy, the present disclosure provides a portable electronic device and a method for adjusting sound output channels according to different orientations.

In order to solve the above-mentioned problems, one of the technical aspects adopted by the present disclosure is to provide a portable electronic device configured for adjusting sound output channels according to different orientations, which includes a device casing structure, a signal control module, an image display module, a first speaker module, a second speaker module, a third speaker module, a fourth speaker module and an orientation detection module. The device casing structure has a first side and a second side corresponding to each other, and a third side and a fourth side corresponding to each other. The signal control module is disposed in the device casing structure. The image display module is configured to cooperate with the device casing structure and electrically connected to the signal control module, and the image display module has an image display area. The first speaker module is disposed inside the device casing structure and electrically connected to the signal control module. The second speaker module is disposed inside the device casing structure and electrically connected to the signal control module. The third speaker module is disposed inside the device casing structure and electrically connected to the signal control module. The fourth speaker module is disposed inside the device casing structure and electrically connected to the signal control module. The orientation detection module is disposed inside the device casing structure and electrically connected to the signal control module. The first speaker module and the second speaker module are configured respectively adjacent to the first side and the second side of the device casing structure. The third speaker module and the fourth speaker module are configured respectively adjacent to the third side and the fourth side of the device casing structure. When the portable electronic device is placed horizontally or approximately horizontally, the signal control module is configured to turn on the first speaker module and the second speaker module and turn off the third speaker module and the fourth speaker module through a horizontal placement signal provided by the orientation detection module, thereby allowing a first audio signal provided by the first speaker module and a second audio signal provided by the second speaker module to cooperate with each other to present a first stereo sound. When the portable electronic device is placed upright or approximately upright, the signal control module is configured to turn on the third speaker module and the fourth speaker module and turn off the first speaker module and the second speaker module through an upright placement signal provided by the orientation detection module, thereby allowing a third audio signal provided by the third speaker module and a fourth audio signal provided by the fourth speaker module to cooperate with each other to present a second stereo sound.

In order to solve the above-mentioned problems, another one of the technical aspects adopted by the present disclosure is to provide a portable electronic device, which includes a device casing structure, a signal control module, an image display module, a first speaker module, a second speaker module, a third speaker module and a fourth speaker module. The device casing structure has a first side and a second side corresponding to each other, and a third side and a fourth side corresponding to each other. The signal control module is disposed in the device casing structure. The image display module is configured to cooperate with the device casing structure and electrically connected to the signal control module, and the image display module has an image display area. The first speaker module is disposed inside the device casing structure and electrically connected to the signal control module. The second speaker module is disposed inside the device casing structure and electrically connected to the signal control module. The third speaker module is disposed inside the device casing structure and electrically connected to the signal control module. The fourth speaker module is disposed inside the device casing structure and electrically connected to the signal control module. The first speaker module and the second speaker module are configured respectively adjacent to the first side and the second side of the device casing structure. The third speaker module and the fourth speaker module are configured respectively adjacent to the third side and the fourth side of the device casing structure.

In order to solve the above-mentioned problems, yet another one of the technical aspects adopted by the present disclosure is to provide a method for adjusting sound output channels according to different orientations, which includes: providing a portable electronic device including a signal control module, a first speaker module, a second speaker module, a third speaker module, a fourth speaker module and an orientation detection module; and detecting an orientation of the portable electronic device through the orientation detection module to obtain a horizontal placement signal or an upright placement signal. When the portable electronic device is placed horizontally or approximately horizontally, the signal control module is configured to turn on the first speaker module and the second speaker module and turn off the third speaker module and the fourth speaker module through the horizontal placement signal provided by the orientation detection module, thereby allowing a first audio signal provided by the first speaker module and a second audio signal provided by the second speaker module to cooperate with each other to present a first stereo sound. When the portable electronic device is placed upright or approximately upright, the signal control module is configured to turn on the third speaker module and the fourth speaker module and turn off the first speaker module and the second speaker module through the upright placement signal provided by the orientation detection module, thereby allowing a third audio signal provided by the third speaker module and a fourth audio signal provided by the fourth speaker module to cooperate with each other to present a second stereo sound. The first speaker module and the second speaker module are configured respectively adjacent to a top side and a bottom side of the portable electronic device. The third speaker module and the fourth speaker module are configured respectively adjacent to a left side and a right side of the portable electronic device.

Therefore, in the portable electronic device for adjusting sound output channels according to different orientations provided by the present disclosure, by virtue of “the first speaker module, the second speaker module, the third speaker module and the fourth speaker module being disposed inside the device casing structure and electrically connected to the signal control module,” “the first speaker module and the second speaker module being configured respectively adjacent to the first side and the second side of the device casing structure” and “the third speaker module and the fourth speaker module being configured respectively adjacent to the third side and the fourth side of the device casing structure,” when the portable electronic device is placed horizontally or approximately horizontally, a first audio signal provided by the first speaker module and a second audio signal provided by the second speaker module can cooperate with each other to present a first stereo sound, or when the portable electronic device is placed upright or approximately upright, a third audio signal provided by the third speaker module and a fourth audio signal provided by the fourth speaker module can cooperate with each other to present a second stereo sound.

Furthermore, in the method for adjusting sound output channels according to different orientations provided by the present disclosure, by virtue of “providing a portable electronic device including a signal control module, a first speaker module, a second speaker module, a third speaker module, a fourth speaker module and an orientation detection module” and “detecting an orientation of the portable electronic device through the orientation detection module to obtain a horizontal placement signal or an upright placement signal,” when the portable electronic device is placed horizontally or approximately horizontally, a first audio signal provided by the first speaker module and a second audio signal provided by the second speaker module can cooperate with each other to present a first stereo sound, or when the portable electronic device is placed upright or approximately upright, a third audio signal provided by the third speaker module and a fourth audio signal provided by the fourth speaker module can cooperate with each other to present a second stereo sound.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a portable electronic device configured for adjusting sound output channels according to different orientations according to a first embodiment of the present disclosure;

FIG. 2 is a functional block diagram of the portable electronic device configured for adjusting output channels according to different orientations according to the first embodiment of the present disclosure;

FIG. 3 is a schematic view of the portable electronic device placed in a horizontal or approximately horizontal orientation according to the first embodiment of the present disclosure;

FIG. 4 is a schematic view of the portable electronic device placed in an upright or approximately upright orientation according to the first embodiment of the present disclosure;

FIG. 5 is a flowchart of a method for adjusting sound output channels according to different orientations according to the first embodiment of the present disclosure;

FIG. 6 is a schematic view of the portable electronic device configured for adjusting sound output channels according to different orientations according to a second embodiment of the present disclosure;

FIG. 7 is a schematic enlarged view of part VII of FIG. 6;

FIG. 8 is a schematic enlarged view of part VIII of FIG. 6;

FIG. 9 is a schematic enlarged view of part IX of FIG. 6; and

FIG. 10 is a schematic enlarged view of part X of FIG. 6.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

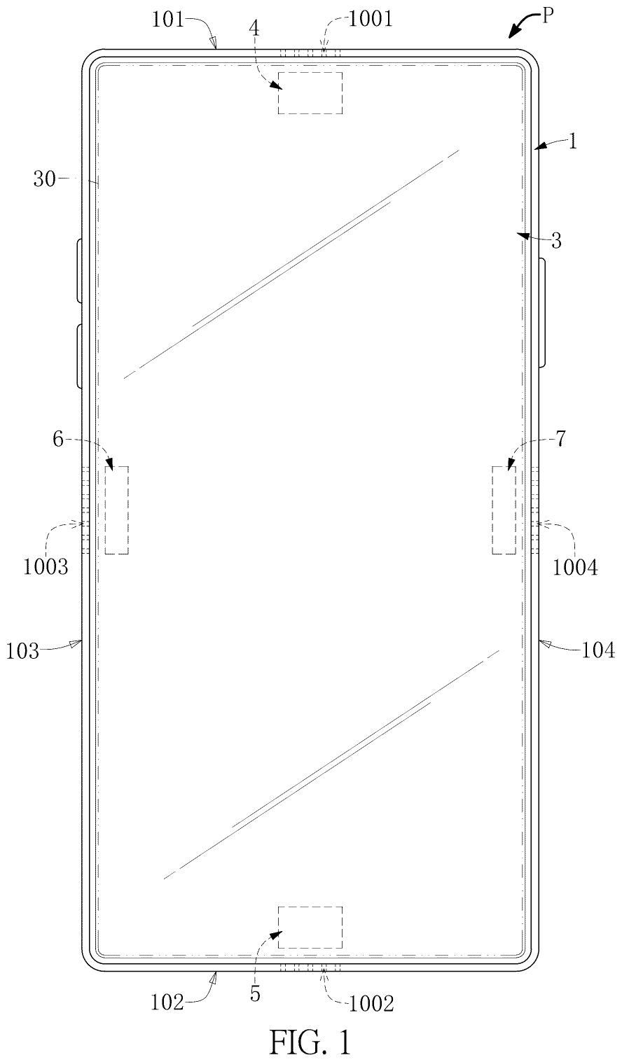

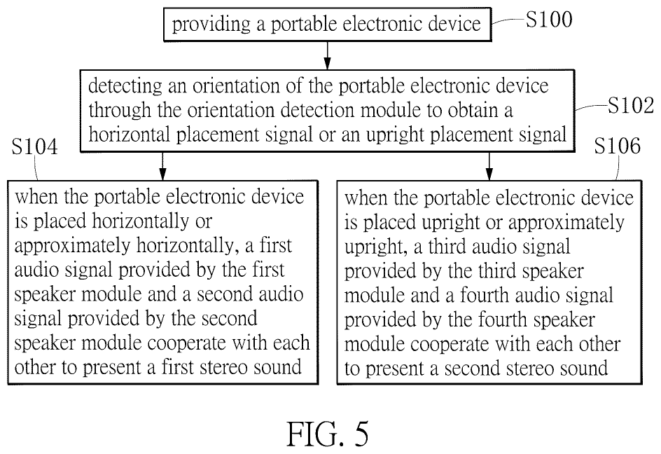

Referring to FIG. 1 to FIG. 10, the present disclosure provides a portable electronic device P configured for adjusting sound output channels according to different orientations, which includes a device casing structure 1, a signal control module 2, an image display module 3, a first speaker module 4, a second speaker module 5, a third speaker module 6 and a fourth speaker module 7. More particularly, the device casing structure 1 has a first side 101 and a second side 102 corresponding to each other, and a third side 103 and a fourth side 104 corresponding to each other. The signal control module 2 can be disposed in the device casing structure 1. The image display module 3 can be configured to cooperate with the device casing structure 1 and electrically connected to the signal control module 2, and the image display module 3 has an image display area 30. The first speaker module 4 can be disposed inside the device casing structure 1 and electrically connected to the signal control module 2. The second speaker module 5 can be disposed inside the device casing structure 1 and electrically connected to the signal control module 2. The third speaker module 6 can be disposed inside the device casing structure 1 and electrically connected to the signal control module 2. The fourth speaker module 7 can be disposed inside the device casing structure 1 and electrically connected to the signal control module 2. It should be noted that the first speaker module 4 and the second speaker module 5 can be configured respectively adjacent to the first side 101 and the second side 102 of the device casing structure 1 (or the first speaker module 4 and the second speaker module 5 can be configured respectively adjacent to a top side and a bottom side of the portable electronic device P), and the third speaker module 6 and the fourth speaker module 7 can be configured respectively adjacent to the third side 103 and the fourth side 104 of the device casing structure 1 (or the third speaker module 6 and the fourth speaker module 7 can be configured respectively adjacent to a left side and a right side of the portable electronic device P).

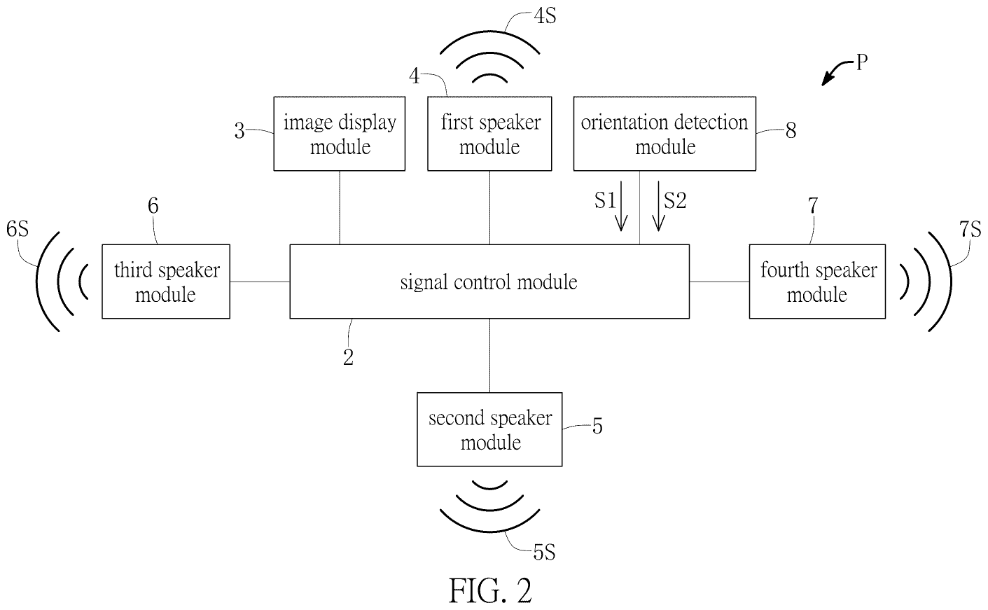

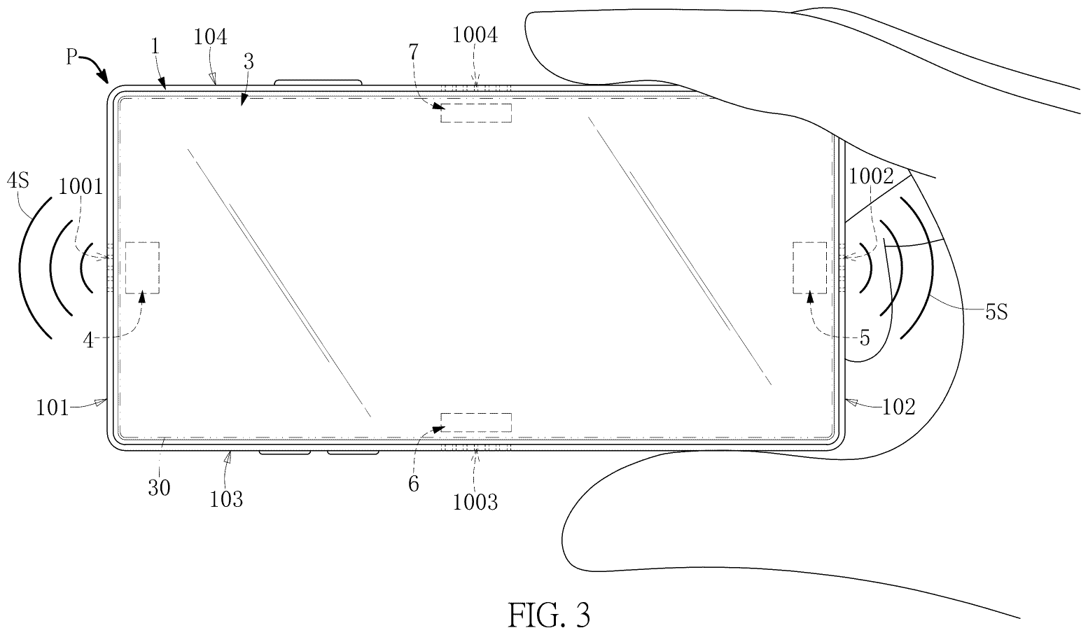

Therefore, referring to FIG. 1, FIG. 2 and FIG. 3, when the portable electronic device P is placed horizontally or approximately (or nearly) horizontally (that is to say, the placement orientation of the portable electronic device P is or is close to a horizontal placement state), the signal control module 2 can be configured to turn on the first speaker module 4 and the second speaker module 5 and turn off the third speaker module 6 and the fourth speaker module 7 through a horizontal placement signal S1 provided (obtained) by the orientation detection module 8, thereby allowing a first audio signal 4S provided by the first speaker module 4 and a second audio signal 5S provided by the second speaker module 5 to cooperate with each other to present a first stereo sound (or a first stereophonic sound signal). In addition, referring to FIG. 1, FIG. 2 and FIG. 3, when the portable electronic device P is placed upright or approximately (or nearly) upright (that is to say, the placement orientation of the portable electronic device P is or is close to a vertical placement state), the signal control module 2 can be configured to turn on the third speaker module 6 and the fourth speaker module 7 and turn off the first speaker module 4 and the second speaker module 5 through an upright placement signal S2 provided (obtained) by the orientation detection module 8, thereby allowing a third audio signal 6S provided by the third speaker module 6 and a fourth audio signal 7S provided by the fourth speaker module 7 to cooperate with each other to present a second stereo sound (or a second stereophonic sound signal).

### First Embodiment

Referring to FIG. 1 to FIG. 4, a first embodiment of the present disclosure provides a portable electronic device P configured for adjusting sound output channels according to different orientations (such as different usage directions or placement directions), which includes a device casing structure 1 (or an outer casing structure), a signal control module 2, an image display module 3, a first speaker module 4, a second speaker module 5, a third speaker module 6, a fourth speaker module 7 and an orientation detection module 8 (can be omitted and not used). For example, the portable electronic device P can be a smartphone, a tablet, or any electronic device that can be used to output sound signals (or sound wave signals). However, the aforementioned details are disclosed for exemplary purposes only, and are not meant to limit the scope of the present disclosure.

More particularly, the device casing structure 1 may have a first side 101, a second side 102, a third side 103 and a fourth side 104, the first side 101 and the second side 102 correspond to each other and are respectively provided at the top side and the bottom side of the portable electronic device P, and the third side 103 and the fourth side 104 correspond to each other and are respectively provided at the top side and the bottom side of the portable electronic device P. In addition, the signal control module 2 (or a signal processing module) can be disposed in the device casing structure 1, the image display module 3 can be configured to cooperate with the device casing structure 1 and electrically connected to the signal control module 2, and the image display module 3 has an image display area 30 configured for displaying image patterns or image frames. For example, the device casing structure 1 has a plurality of first audio openings 1001 (such as any shape of opening) formed on the first side 101 thereof, a plurality of second audio openings 1002 (such as any shape of opening) formed on the second side 102 thereof, a plurality of third audio openings 1003 (such as any shape of opening) formed on the third side 103 thereof, and a plurality of fourth audio openings 1004 (such as any shape of opening) formed on the fourth side 104 thereof. In addition, the image display module 3 can be a liquid crystal display (LCD), a light-emitting diode (LED) display, an organic light-emitting diode display or any kind of display. However, the aforementioned details are disclosed for exemplary purposes only, and are not meant to limit the scope of the present disclosure.

More particularly, referring to FIG. 1 and FIG. 2, the first speaker module 4 is disposed inside the device casing structure 1 and electrically connected to the signal control module 2, and the second speaker module 5 is disposed inside the device casing structure 1 and electrically connected to the signal control module 2. In addition, the first speaker module 4 and the second speaker module 5 can be configured respectively adjacent to the first side 101 and the second side 102 of the device casing structure 1. For example, the first speaker module 4 and the second speaker module 5 may be electric speakers, piezoelectric speakers, electrode speakers, plasma speakers, MEMS (Micro Electro Mechanical Systems) speakers or any kind of sound output module. Moreover, when the first speaker module 4 can be configured to generate a first audio signal 4S (or a first sound signal), the first audio signal 4S generated by the first speaker module 4 can be transmitted out from the first audio openings 1001 of the device casing structure 1 so as to output the first audio signal 4S. In addition, when the second speaker module 5 can be configured to generate a second audio signal 5S (or a second sound signal), the second audio signal 5S generated by the second speaker module 5 can be transmitted out from the second audio openings 1002 of the device casing structure 1 so as to output the second audio signal 5S. It should be noted that as shown in FIG. 1, a vertical projection of the first speaker module 4 can completely fall on the image display area 30 of the image display module 3 (alternatively, when the coverage of the image display area 30 is reduced, the vertical projection of the first speaker module 4 can partially fall on the image display area 30 of the image display module 3), and a vertical projection of the second speaker module 5 can completely fall on the image display area 30 of the image display module 3 (alternatively, when the coverage of the image display area 30 is reduced, the vertical projection of the second speaker module 5 can partially fall on the image display area 30 of the image display module 3). However, the aforementioned details are disclosed for exemplary purposes only, and are not meant to limit the scope of the present disclosure.

More particularly, referring to FIG. 1 and FIG. 2, the third speaker module 6 is disposed inside the device casing structure 1 and electrically connected to the signal control module 2, and the fourth speaker module 7 is disposed inside the device casing structure 1 and electrically connected to the signal control module 2. In addition, the third speaker module 6 and the fourth speaker module 7 can be configured respectively adjacent to the third side 103 and the fourth side 104 of the device casing structure 1. For example, the third speaker module 6 and the fourth speaker module 7 may be electric speakers, piezoelectric speakers, electrode speakers, plasma speakers, MEMS (Micro Electro Mechanical Systems) speakers or any kind of sound output module. Moreover, when the third speaker module 6 can be configured to generate a third audio signal 6S (or a third sound signal), the third audio signal 6S generated by the third speaker module 6 can be transmitted out from the third audio openings 1003 of the device casing structure 1 so as to output the third audio signal 6S. In addition, when the fourth speaker module 7 can be configured to generate a fourth audio signal 7S (or a fourth sound signal), the fourth audio signal 7S generated by the fourth speaker module 7 can be transmitted out from the fourth audio openings 1004 of the device casing structure 1 so as to output the fourth audio signal 7S. It should be noted that as shown in FIG. 1, a vertical projection of the third speaker module 6 can completely fall on the image display area 30 of the image display module 3 (alternatively, when the coverage of the image display area 30 is reduced, the vertical projection of the third speaker module 6 can partially fall on the image display area 30 of the image display module 3), and a vertical projection of the fourth speaker module 7 can completely fall on the image display area 30 of the image display module 3 (alternatively, when the coverage of the image display area 30 is reduced, the vertical projection of the fourth speaker module 7 can partially fall on the image display area 30 of the image display module 3). However, the aforementioned details are disclosed for exemplary purposes only, and are not meant to limit the scope of the present disclosure.

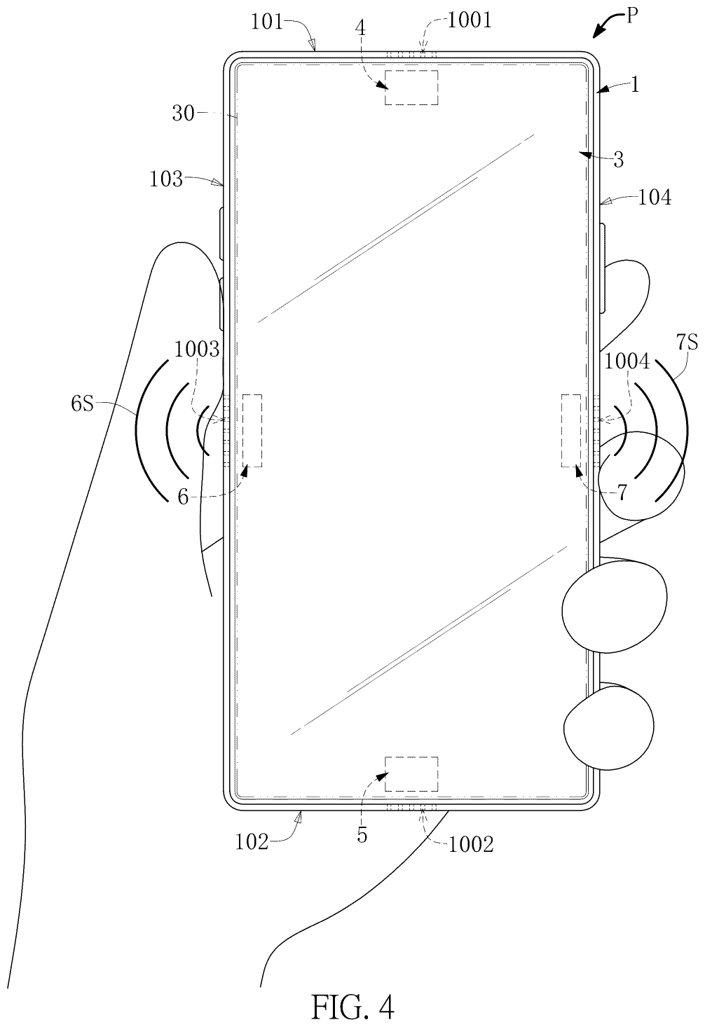

More particularly, referring to FIG. 2, FIG. 3 and FIG. 4, the orientation detection module 8 is disposed inside the device casing structure 1 and electrically connected to the signal control module 2, and the orientation detection module 8 can be configured to detect the usage orientation or placement orientation of the portable electronic device P relative to the user (or relative to the ground), thereby obtaining a horizontal placement signal S1 (that is to say, a horizontal orientation signal corresponding to the horizontal screen display state of the portable electronic device P as shown FIG. 3) or an upright placement signal S2 (that is to say, a vertical orientation signal corresponding to the upright screen display state of the portable electronic device P as shown FIG. 4). For example, according to different requirements, the orientation detection module 8 can be any type of motion sensor, such as a gravity sensor, an accelerometer sensor, a gyroscope, a rotation vector sensor, or any type of detector that can be used to obtain the orientation signal of the portable electronic device P. However, the aforementioned details are disclosed for exemplary purposes only, and are not meant to limit the scope of the present disclosure.

Therefore, referring to FIG. 1, FIG. 2 and FIG. 3, when the portable electronic device P is placed horizontally or approximately horizontally, the signal control module 2 can be configured to turn on (or simultaneously turn on) the first speaker module 4 and the second speaker module 5 and turn off (or simultaneously turn off) the third speaker module 6 and the fourth speaker module 7 through a horizontal placement signal S1 provided (obtained) by the orientation detection module 8 (or through a horizontal screen signal provided by the image display area 30 of the image display module 3), thereby allowing a first audio signal 4S provided by the first speaker module 4 and a second audio signal 5S provided by the second speaker module 5 to cooperate with each other to present a first stereo sound. It should be noted that when the first speaker module 4 and the second speaker module 5 are turned on simultaneously (or synchronously), the third speaker module 6 and the fourth speaker module 7 are turned off simultaneously (or synchronously), so that the portable electronic device P can be configured to provide the first stereo sound through the cooperation of the first speaker module 4 and the second speaker module 5 only (as shown in FIG. 3).

Moreover, referring to FIG. 1, FIG. 2 and FIG. 4, when the portable electronic device P is placed upright or approximately upright, the signal control module 2 can be configured to turn on (or simultaneously turn on) the third speaker module 6 and the fourth speaker module 7 and turn off (or simultaneously turn off) the first speaker module 4 and the second speaker module 5 through an upright placement signal S2 provided (obtained) by the orientation detection module 8 (or through an upright screen signal provided by the image display area 30 of the image display module 3), thereby allowing a third audio signal 6S provided by the third speaker module 6 and a fourth audio signal 7S provided by the fourth speaker module 7 to cooperate with each other to present a second stereo sound. It should be noted that when the third speaker module 6 and the fourth speaker module 7 are turned on simultaneously (or synchronously), the first speaker module 4 and the second speaker module 5 are turned off simultaneously (or synchronously), so that the portable electronic device P can be configured to provide the second stereo sound through the cooperation of the third speaker module 6 and the fourth speaker module 7 only (as shown in FIG. 4).

More particularly, referring to FIG. 1 to FIG. 5, the first embodiment of the present disclosure further includes a method for adjusting sound output channels according to different orientations (such as different usage directions or placement directions), which includes: firstly, referring to FIG. 1 and FIG. 2, providing a portable electronic device P including a signal control module 2, a first speaker module 4, a second speaker module 5, a third speaker module 6, a fourth speaker module 7 and an orientation detection module 8 (can be omitted and not used) (step S100); and then referring to FIG. 1, FIG. 2, FIG. 3 and FIG. 4, detecting an orientation (a usage position) of the portable electronic device P through the orientation detection module 8 to obtain a horizontal placement signal S1 or an upright placement signal S2 (step S102), or obtaining a horizontal screen signal or an upright screen signal provided through the image display area 30 of the image display module 3.

Therefore, referring to FIG. 1, FIG. 2 and FIG. 3, when the portable electronic device P is placed horizontally or approximately horizontally, the signal control module 2 can be configured to turn on (or simultaneously turn on) the first speaker module 4 and the second speaker module 5 and turn off (or simultaneously turn off) the third speaker module 6 and the fourth speaker module 7 through a horizontal placement signal S1 provided (obtained) by the orientation detection module 8 (or through a horizontal screen signal provided by the image display area 30 of the image display module 3), thereby allowing a first audio signal 4S provided by the first speaker module 4 and a second audio signal 5S provided by the second speaker module 5 to cooperate with each other to present a first stereo sound (step S104). In addition, referring to FIG. 1, FIG. 2 and FIG. 4, when the portable electronic device P is placed upright or approximately upright, the signal control module 2 can be configured to turn on (or simultaneously turn on) the third speaker module 6 and the fourth speaker module 7 and turn off (or simultaneously turn off) the first speaker module 4 and the second speaker module 5 through an upright placement signal S2 provided (obtained) by the orientation detection module 8 (or through an upright screen signal provided by the image display area 30 of the image display module 3), thereby allowing a third audio signal 6S provided by the third speaker module 6 and a fourth audio signal 7S provided by the fourth speaker module 7 to cooperate with each other to present a second stereo sound (step S106).

### Second Embodiment

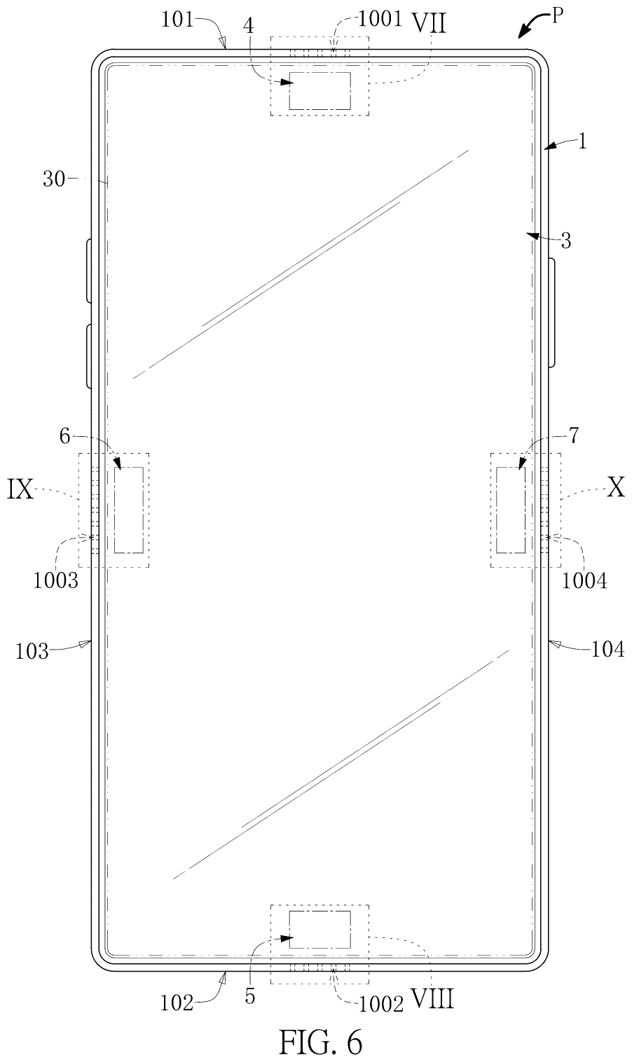

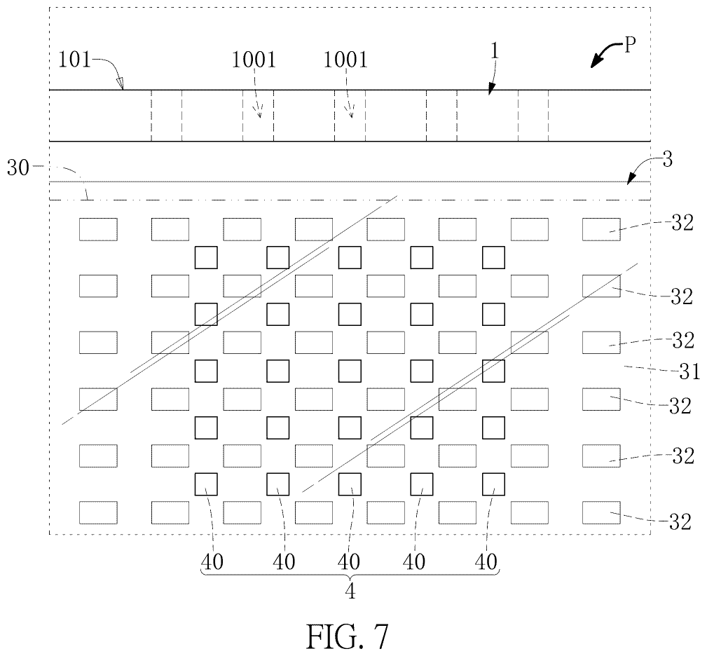

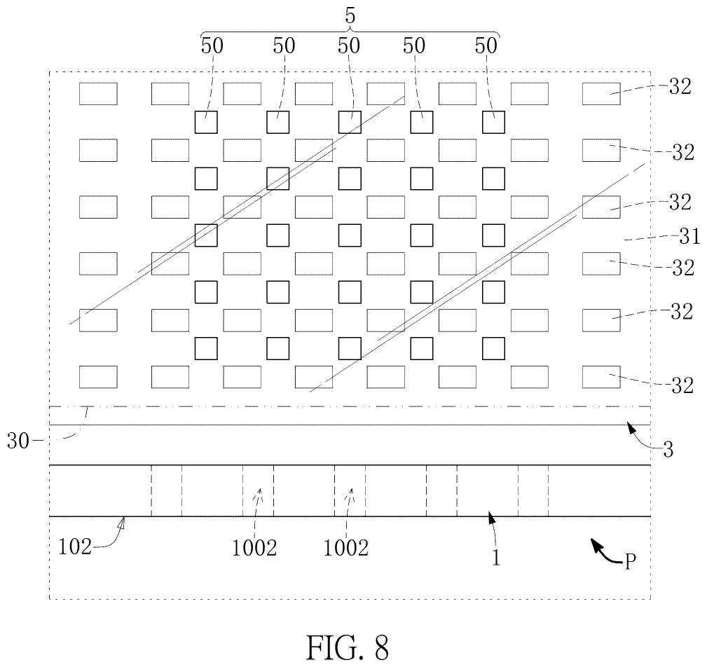

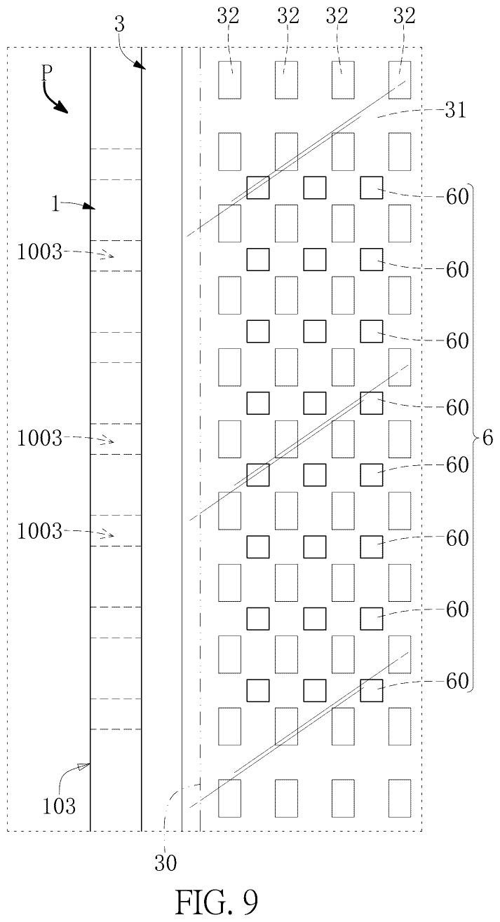

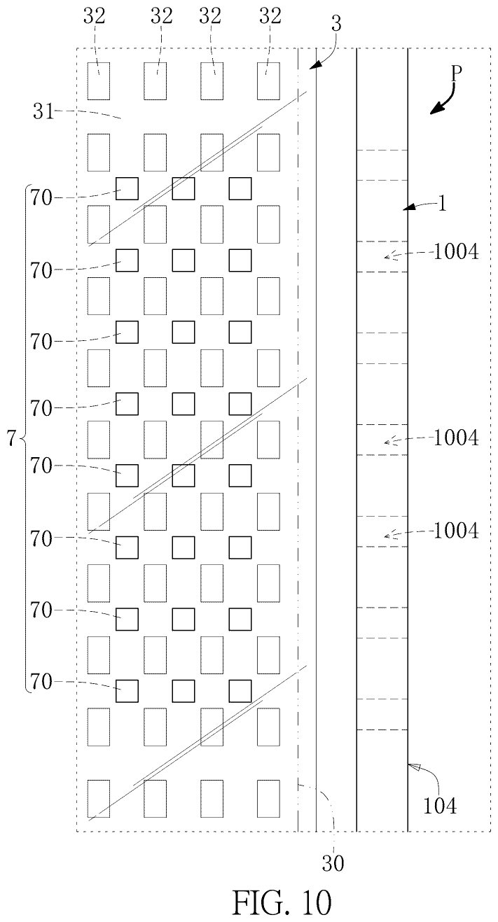

Referring to FIG. 6 to FIG. 10, a second embodiment of the present disclosure provides a portable electronic device P configured for adjusting sound output channels according to different orientations (such as different usage directions or placement directions), which includes a device casing structure 1, a signal control module (not shown, but can refer to FIG. 2), an image display module 3, a first speaker module 4, a second speaker module 5, a third speaker module 6, a fourth speaker module 7 and an orientation detection module (can be omitted and not used). The main difference between the second embodiment and the first embodiment is as follows: in the second embodiment, the first speaker module 4 includes a plurality of first speaker chips 40 (as shown in FIG. 7), the second speaker module 5 includes a plurality of second speaker chips 50 (as shown in FIG. 8), the third speaker module 6 includes a plurality of third speaker chips 60 (as shown in FIG. 9), and the fourth speaker module 7 includes a plurality of fourth speaker chips 70 (as shown in FIG. 10).

More particularly, referring to FIG. 6 and FIG. 7, when the first speaker module 4 can be configured to generate a first audio signal 4S through the first speaker chips 40, the first audio signal 4S generated by the first speaker module 4 can be transmitted out from the first audio openings 1001 of the device casing structure 1 so as to output the first audio signal 4S. It should be noted that the first audio signal 4S generated by the first speaker module 4 can also be directly transmitted through the transparent protective glass (not labeled) provided above the image display module 3 and transmitted directly toward the user. For example, as shown in FIG. 7, the first speaker chips 40 can be separated from each other and arranged in a specific shape (or the first speaker chips 40 can also be connected to each other through a carrier substrate to form a single module chip), and each first speaker chip 40 may be a MEMS speaker manufactured through a semiconductor process. However, the aforementioned details are disclosed for exemplary purposes only, and are not meant to limit the scope of the present disclosure.

More particularly, referring to FIG. 6 and FIG. 8, when the second speaker module 5 can be configured to generate a second audio signal 5S through the second speaker chips 50, the second audio signal 5S generated by the second speaker module 5 can be transmitted out from the second audio openings 1002 of the device casing structure 1 so as to output the second audio signal 5S. It should be noted that the second audio signal 5S generated by the second speaker module 5 can also be directly transmitted through the transparent protective glass (not labeled) provided above the image display module 3 and transmitted directly toward the user. For example, as shown in FIG. 8, the second speaker chips 50 can be separated from each other and arranged in a specific shape (or the second speaker chips 50 can also be connected to each other through a carrier substrate to form a single module chip), and each second speaker chip 50 may be a MEMS speaker manufactured through a semiconductor process. However, the aforementioned details are disclosed for exemplary purposes only, and are not meant to limit the scope of the present disclosure.

More particularly, referring to FIG. 6 and FIG. 9, when the third speaker module 6 can be configured to generate a third audio signal 6S through the third speaker chips 60, the third audio signal 6S generated by the third speaker module 6 can be transmitted out from the third audio openings 1003 of the device casing structure 1 so as to output the third audio signal 6S. It should be noted that the third audio signal 6S generated by the third speaker module 6 can also be directly transmitted through the transparent protective glass (not labeled) provided above the image display module 3 and transmitted directly toward the user. For example, as shown in FIG. 9, the third speaker chips 60 can be separated from each other and arranged in a specific shape (or the third speaker chips 60 can also be connected to each other through a carrier substrate to form a single module chip), and each third speaker chip 60 may be a MEMS speaker manufactured through a semiconductor process. However, the aforementioned details are disclosed for exemplary purposes only, and are not meant to limit the scope of the present disclosure.

More particularly, referring to FIG. 6 and FIG. 10, when the fourth speaker module 7 can be configured to generate a fourth audio signal 7S through the fourth speaker chips 70, the fourth audio signal 7S generated by the fourth speaker module 7 can be transmitted out from the fourth audio openings 1004 of the device casing structure 1 so as to output the fourth audio signal 7S. It should be noted that the fourth audio signal 7S generated by the fourth speaker module 7 can also be directly transmitted through the transparent protective glass (not labeled) provided above the image display module 3 and transmitted directly toward the user. For example, as shown in FIG. 10, the fourth speaker chips 70 can be separated from each other and arranged in a specific shape (or the fourth speaker chips 70 can also be connected to each other through a carrier substrate to form a single module chip), and each fourth speaker chip 70 may be a MEMS speaker manufactured through a semiconductor process. However, the aforementioned details are disclosed for exemplary purposes only, and are not meant to limit the scope of the present disclosure.

It should be noted that, for example, referring to FIG. 7, FIG. 8, FIG. 9 and FIG. 10, when the image display module 3 can be a light-emitting diode display (or an organic light-emitting diode display), the light-emitting diode display includes a circuit substrate 31 and a plurality of light-emitting diode chips 32 (or a plurality of organic light-emitting diode chips) disposed on the circuit substrate 31, and the first speaker chips 40 of the first speaker module 4, the second speaker chips 50 of the second speaker module 5, the third speaker chips 60 of the third speaker module 6 and the fourth speaker chips 70 of the fourth speaker module 7 can be disposed on the circuit substrate 31 and surrounded by the light-emitting diode chips 32 (or each first speaker chip 40, each second speaker chip 50, each third speaker chip 60 or each fourth speaker chip 70 can be surrounded by at least four light-emitting diode chips 32). However, the aforementioned details are disclosed for exemplary purposes only, and are not meant to limit the scope of the present disclosure.

### BENEFICIAL EFFECTS OF THE EMBODIMENTS

In conclusion, in the portable electronic device P for adjusting sound output channels according to different orientations provided by the present disclosure, by virtue of “the first speaker module 4, the second speaker module 5, the third speaker module 6 and the fourth speaker module 7 being disposed inside the device casing structure 1 and electrically connected to the signal control module 2,” “the first speaker module 4 and the second speaker module 5 being configured respectively adjacent to the first side 101 and the second side 102 of the device casing structure 1” and “the third speaker module 6 and the fourth speaker module 7 being configured respectively adjacent to the third side 103 and the fourth side 104 of the device casing structure 1,” when the portable electronic device P is placed horizontally or approximately horizontally, a first audio signal 4S provided by the first speaker module 4 and a second audio signal 5S provided by the second speaker module 5 can cooperate with each other to present a first stereo sound, or when the portable electronic device P is placed upright or approximately upright, a third audio signal 6S provided by the third speaker module 6 and a fourth audio signal 7S provided by the fourth speaker module 7 can cooperate with each other to present a second stereo sound.

Furthermore, in the method for adjusting sound output channels according to different orientations provided by the present disclosure, by virtue of “providing a portable electronic device P including a signal control module 2, a first speaker module 4, a second speaker module 5, a third speaker module 6, a fourth speaker module 7 and an orientation detection module 8” and “detecting an orientation of the portable electronic device P through the orientation detection module 8 to obtain a horizontal placement signal S1 or an upright placement signal S2,” when the portable electronic device P is placed horizontally or approximately horizontally, a first audio signal 4S provided by the first speaker module 4 and a second audio signal 5S provided by the second speaker module 5 can cooperate with each other to present a first stereo sound, or when the portable electronic device P is placed upright or approximately upright, a third audio signal 6S provided by the third speaker module 6 and a fourth audio signal 7S provided by the fourth speaker module 7 can cooperate with each other to present a second stereo sound.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A portable electronic device configured for adjusting sound output channels according to different orientations, comprising:
a device casing structure having a first side and a second side corresponding to each other, and a third side and a fourth side corresponding to each other;
a signal control module disposed in the device casing structure;
an image display module configured to cooperate with the device casing structure and electrically connected to the signal control module, wherein the image display module has an image display area;
a first speaker module disposed inside the device casing structure and electrically connected to the signal control module;
a second speaker module disposed inside the device casing structure and electrically connected to the signal control module;
a third speaker module disposed inside the device casing structure and electrically connected to the signal control module;
a fourth speaker module disposed inside the device casing structure and electrically connected to the signal control module; and
an orientation detection module disposed inside the device casing structure and electrically connected to the signal control module;
wherein the first speaker module and the second speaker module are configured respectively adjacent to the first side and the second side of the device casing structure;
wherein the third speaker module and the fourth speaker module are configured respectively adjacent to the third side and the fourth side of the device casing structure;
wherein, when the portable electronic device is placed horizontally or approximately horizontally, the signal control module is configured to turn on the first speaker module and the second speaker module and turn off the third speaker module and the fourth speaker module through a horizontal placement signal provided by the orientation detection module, thereby allowing a first audio signal provided by the first speaker module and a second audio signal provided by the second speaker module to cooperate with each other to present a first stereo sound;
wherein, when the portable electronic device is placed upright or approximately upright, the signal control module is configured to turn on the third speaker module and the fourth speaker module and turn off the first speaker module and the second speaker module through an upright placement signal provided by the orientation detection module, thereby allowing a third audio signal provided by the third speaker module and a fourth audio signal provided by the fourth speaker module to cooperate with each other to present a second stereo sound.

2. The portable electronic device according to claim 1,
wherein the first speaker module includes a plurality of first speaker chips, and the first speaker chips are separated from each other or connected to each other;
wherein the second speaker module includes a plurality of second speaker chips, and the second speaker chips are separated from each other or connected to each other;
wherein the third speaker module includes a plurality of third speaker chips, and the third speaker chips are separated from each other or connected to each other;
wherein the fourth speaker module includes a plurality of fourth speaker chips, and the fourth speaker chips are separated from each other or connected to each other.

3. The portable electronic device according to claim 2,
wherein the device casing structure has a plurality of first audio openings formed on the first side thereof, a plurality of second audio openings formed on the second side thereof, a plurality of third audio openings formed on the third side thereof, and a plurality of fourth audio openings formed on the fourth side thereof,
wherein, when the first speaker module is configured to generate a first audio signal through the first speaker chips, the first audio signal generated by the first speaker module is transmitted out from the first audio openings of the device casing structure;
wherein, when the second speaker module is configured to generate a second audio signal through the second speaker chips, the second audio signal generated by the second speaker module is transmitted out from the second audio openings of the device casing structure;
wherein, when the third speaker module is configured to generate a third audio signal through the third speaker chips, the third audio signal generated by the third speaker module is transmitted out from the third audio openings of the device casing structure;
wherein, when the fourth speaker module is configured to generate a fourth audio signal through the fourth speaker chips, the fourth audio signal generated by the fourth speaker module is transmitted out from the fourth audio openings of the device casing structure;
wherein, when the first speaker module and the second speaker module are turned on simultaneously, the third speaker module and the fourth speaker module are turned off simultaneously, so that the portable electronic device is configured to provide the first stereo sound through the cooperation of the first speaker module and the second speaker module only;
wherein, when the third speaker module and the fourth speaker module are turned on simultaneously, the first speaker module and the second speaker module are turned off simultaneously, so that the portable electronic device is configured to provide the second stereo sound through the cooperation of the third speaker module and the fourth speaker module only.

4. The portable electronic device according to claim 1,
wherein a vertical projection of the first speaker module completely or partially falls on the image display area of the image display module;
wherein a vertical projection of the second speaker module completely or partially falls on the image display area of the image display module;
wherein a vertical projection of the third speaker module completely or partially falls on the image display area of the image display module;
wherein a vertical projection of the fourth speaker module completely or partially falls on the image display area of the image display module;
wherein the image display module is a liquid crystal display or a light-emitting diode display;
wherein, when the image display module is a light-emitting diode display, the light-emitting diode display includes a circuit substrate and a plurality of light-emitting diode chips disposed on the circuit substrate, and the first speaker chips of the first speaker module, the second speaker chips of the second speaker module, the third speaker chips of the third speaker module and the fourth speaker chips of the fourth speaker module are disposed on the circuit substrate and surrounded by the light-emitting diode chips.

5. A portable electronic device, comprising:
a device casing structure having a first side and a second side corresponding to each other, and a third side and a fourth side corresponding to each other;
a signal control module disposed in the device casing structure;
an image display module configured to cooperate with the device casing structure and electrically connected to the signal control module, wherein the image display module has an image display area;
a first speaker module disposed inside the device casing structure and electrically connected to the signal control module;
a second speaker module disposed inside the device casing structure and electrically connected to the signal control module;
a third speaker module disposed inside the device casing structure and electrically connected to the signal control module; and
a fourth speaker module disposed inside the device casing structure and electrically connected to the signal control module;
wherein the first speaker module and the second speaker module are configured respectively adjacent to the first side and the second side of the device casing structure;
wherein the third speaker module and the fourth speaker module are configured respectively adjacent to the third side and the fourth side of the device casing structure.

6. The portable electronic device according to claim 5,
wherein the first speaker module includes a plurality of first speaker chips, and the first speaker chips are separated from each other or connected to each other;
wherein the second speaker module includes a plurality of second speaker chips, and the second speaker chips are separated from each other or connected to each other;
wherein the third speaker module includes a plurality of third speaker chips, and the third speaker chips are separated from each other or connected to each other;
wherein the fourth speaker module includes a plurality of fourth speaker chips, and the fourth speaker chips are separated from each other or connected to each other.

7. The portable electronic device according to claim 6,
wherein the device casing structure has a plurality of first audio openings formed on the first side thereof, a plurality of second audio openings formed on the second side thereof, a plurality of third audio openings formed on the third side thereof, and a plurality of fourth audio openings formed on the fourth side thereof;
wherein, when the first speaker module is configured to generate a first audio signal through the first speaker chips, the first audio signal generated by the first speaker module is transmitted out from the first audio openings of the device casing structure;
wherein, when the second speaker module is configured to generate a second audio signal through the second speaker chips, the second audio signal generated by the second speaker module is transmitted out from the second audio openings of the device casing structure;
wherein, when the third speaker module is configured to generate a third audio signal through the third speaker chips, the third audio signal generated by the third speaker module is transmitted out from the third audio openings of the device casing structure;
wherein, when the fourth speaker module is configured to generate a fourth audio signal through the fourth speaker chips, the fourth audio signal generated by the fourth speaker module is transmitted out from the fourth audio openings of the device casing structure.

8. The portable electronic device according to claim 5,
wherein a vertical projection of the first speaker module completely or partially falls on the image display area of the image display module;
wherein a vertical projection of the second speaker module completely or partially falls on the image display area of the image display module;
wherein a vertical projection of the third speaker module completely or partially falls on the image display area of the image display module;
wherein a vertical projection of the fourth speaker module completely or partially falls on the image display area of the image display module;
wherein the image display module is a liquid crystal display or a light-emitting diode display;
wherein, when the image display module is a light-emitting diode display, the light-emitting diode display includes a circuit substrate and a plurality of light-emitting diode chips disposed on the circuit substrate, and the first speaker chips of the first speaker module, the second speaker chips of the second speaker module, the third speaker chips of the third speaker module and the fourth speaker chips of the fourth speaker module are disposed on the circuit substrate and surrounded by the light-emitting diode chips.

9. A method for adjusting sound output channels according to different orientations, comprising:
providing a portable electronic device including a signal control module, a first speaker module, a second speaker module, a third speaker module, a fourth speaker module and an orientation detection module; and
detecting an orientation of the portable electronic device through the orientation detection module to obtain a horizontal placement signal or an upright placement signal;
wherein, when the portable electronic device is placed horizontally or approximately horizontally, the signal control module is configured to turn on the first speaker module and the second speaker module and turn off the third speaker module and the fourth speaker module through the horizontal placement signal provided by the orientation detection module, thereby allowing a first audio signal provided by the first speaker module and a second audio signal provided by the second speaker module to cooperate with each other to present a first stereo sound;
wherein, when the portable electronic device is placed upright or approximately upright, the signal control module is configured to turn on the third speaker module and the fourth speaker module and turn off the first speaker module and the second speaker module through the upright placement signal provided by the orientation detection module, thereby allowing a third audio signal provided by the third speaker module and a fourth audio signal provided by the fourth speaker module to cooperate with each other to present a second stereo sound;
wherein the first speaker module and the second speaker module are configured respectively adjacent to a top side and a bottom side of the portable electronic device;
wherein the third speaker module and the fourth speaker module are configured respectively adjacent to a left side and a right side of the portable electronic device.

10. The method according to claim 9,
wherein the first speaker module includes a plurality of first speaker chips, and the first speaker chips are separated from each other or connected to each other;
wherein the second speaker module includes a plurality of second speaker chips, and the second speaker chips are separated from each other or connected to each other;
wherein the third speaker module includes a plurality of third speaker chips, and the third speaker chips are separated from each other or connected to each other;
wherein the fourth speaker module includes a plurality of fourth speaker chips, and the fourth speaker chips are separated from each other or connected to each other;
wherein the portable electronic device includes a device casing structure having a first side and a second side corresponding to each other, and a third side and a fourth side corresponding to each other, the first speaker module and the second speaker module are configured respectively adjacent to the first side and the second side of the device casing structure, and the third speaker module and the fourth speaker module are configured respectively adjacent to the third side and the fourth side of the device casing structure;
wherein the device casing structure has a plurality of first audio openings formed on the first side thereof, a plurality of second audio openings formed on the second side thereof, a plurality of third audio openings formed on the third side thereof, and a plurality of fourth audio openings formed on the fourth side thereof,
wherein, when the first speaker module is configured to generate a first audio signal through the first speaker chips, the first audio signal generated by the first speaker module is transmitted out from the first audio openings of the device casing structure;
wherein, when the second speaker module is configured to generate a second audio signal through the second speaker chips, the second audio signal generated by the second speaker module is transmitted out from the second audio openings of the device casing structure;
wherein, when the third speaker module is configured to generate a third audio signal through the third speaker chips, the third audio signal generated by the third speaker module is transmitted out from the third audio openings of the device casing structure;
wherein, when the fourth speaker module is configured to generate a fourth audio signal through the fourth speaker chips, the fourth audio signal generated by the fourth speaker module is transmitted out from the fourth audio openings of the device casing structure.
